(19) United States
(12) Patent Application Publication
(10) Pub. No.: US 2006/0189478 A1
(43) Pub. Date: Aug. 24, 2006

(54) Organometallic catalyst compositions and process for polyurethane manufacture using said catalyst

(76) Inventors: Bruno Frederic Stengel, Cleveland (GB); Neville Slack, Cleveland (GB); Martin Graham Partidge, Cleveland (GB)

Correspondence Address: RATNERPRESTIA, P O BOX 980, VALLEY FORGE, PA, 19482-0980, US

(21) Appl. No.: 10/537,687

(22) PCT Filed: Dec. 1, 2003
(86) PCT No.: PCT/GB03/05182

§ 371 Date: Dec. 6, 2005

(30) Foreign Application Priority Data
Dec. 4, 2002 (GB) 0228268.9
Dec. 19, 2002 (GB) 0229498.1

(51) Int. Cl. B01J 31/00

(52) U.S. Cl. 502/150; 502/172; 502/170

(57) ABSTRACT

A catalyst composition comprises the reaction product of an alkoxide or condensed alkoxide of titanium, zirconium, hafnium, aluminium, iron (III), or a lanthanide, a 2-hydroxy carboxylic acid, a base and optionally an alcohol containing at least two hydroxyl groups. A process for the manufacture of polyurethane materials using the catalyst is also described.

The invention concerns a novel organometallic catalyst which is particularly suitable for use in the manufacture of polyurethane materials and also processes for the manufacture of polyurethanes using the organometallic catalysts.

Catalysts comprising compounds of titanium or zirconium are well known for use in many applications such as in esterification reactions and for curing reaction mixtures containing isocyanate and hydroxylic species to form polyurethanes. Typically, such catalysts comprise a metal alkoxide, such as titanium tetra isopropoxide, or a chelated species derived from the alkoxides.

In polyurethane manufacture the catalysts of choice in many applications have, for many years, been organic mercury and tin compounds. This is because these catalysts provide a desirable reaction profile which offers an initial induction period in which the reaction is either very slow or does not take place, followed by a rapid reaction which continues for sufficient time to produce a relatively hard polymer article. The induction time, also known as the “cream time”, is desirable because it allows the liquid reaction mixture to be poured or moulded after addition of the catalyst and therefore gives the manufacturer more control over the manufacturing process. The rapid and complete reaction after the cream time is important to provide finished articles which are not sticky and which develop their desired physical properties quickly to allow fast turnaround in the production facility.

It is, however, known that mercury compounds are toxic and so there is a need for catalysts which do not contain mercury and yet which offer the manufacturer the desirable reaction profile which is offered by the known mercury-containing catalysts. Tin catalysts, such as dibutyltin dilaurate, are used extensively in polyurethane manufacture and are especially widely used in the manufacture of polyurethane foam articles. However, there are some concerns about the use of tin catalysts, especially in applications where people are exposed to the finished article for long periods, e.g. in furniture foam or shoe soles, because they may contain undesirable alkyl tin impurities. Although titanium alkoxides provide very effective catalysts for polyurethane cure reactions, they do not produce a reaction profile with the desirable cream time and cure profile described above. In many cases the reaction may be very rapid but offers no induction period and so the polyurethane mixture tends to gel very quickly, often before it can be cast into its final shape. A further problem is that, despite the rapid initial reaction, the resulting polyurethane does not achieve a satisfactory degree of cure within a reasonable time. This results in finished articles which are sticky and difficult to handle and which may have inferior physical properties compared with articles made using a mercury catalyst.

It is an object of the invention to provide a catalyst compound which does not contain mercury and which may be used to manufacture polyurethane articles. It is a further object of the invention to provide a catalyst which is stable in contact with water so that it may be used in polyurethane compositions and reactant formulations intended for polyurethane foams which often contain water as a blowing agent.

Monoalkoxytitanates such as titanium monoisopropoxy tris(isostearate) are well known for use as coupling agents between inorganic materials and organic polymeric materials. For example U.S. Pat. No. 4,397,983 discloses the use of isopropyl tri(dodecylbenzenesulfononyl)titanate and isopropyl tri(dioctylphosphato)titanate for coupling fillers in polyurethanes.

U.S. Pat. No. 4,122,062 describes organotitanates having one of the following formulas:
a) (RO)_{z}Ti(A)ₓ(B)_{y} or
b) (RO)Ti(OCOR′)ₚ(OAr)_{q} wherein R is a monovalent alkyl, alkenyl, alkynyl, or aralkyl group having from 1 to 30 carbon atoms or substituted derivatives thereof; A is a thioaroxy, sulfonyl, sulfinyl, diester pyrophosphate, diester phosphate, or a substituted derivative thereof; OAr is aroxy; B is OCOR′or OAr; R′is hydrogen or a monovalent organic group having from 1 to 100 carbon atoms; x+y+z equal 4; p+q equal 3; x, z and q may be 1, 2 or 3; and y and p may be 0, 1 or 2; the reaction products of such organo-titanates and comminuted inorganic material; and polymeric materials containing such reaction products

U.S. Pat. No. 4,094,853 describes a composition of matter comprising the reaction product of a comminuted inorganic material and an organo-titanate having the formula (RO)Ti(OCOR′)₃ wherein R is a monovalent alkyl, alkenyl, alkynyl or aralkyl group having from 1 to 30 carbon atoms or a substituted derivative thereof, R′ is a monovalent organic group the total number of carbon atoms in the three R′ groups in a molecule being not more than 14; and polymeric materials containing such reaction products.

EP-A-0164227 describes neoalkoxy compounds having the formula
R R¹R² CCH₂OM(A)ₐ(B)_{b}(C)_{c} wherein M is titanium or zirconium, R, R¹ and R² are each a monovalent alkyl, alkenyl, alkynyl, aralkyl, aryl or alkaryl group having up to twenty carbon atoms or a halogen or ether substituted derivative thereof, and, in addition, R² may also be an oxy derivative or an ether substituted oxy derivative of said groups; A, B, and C are each a monovalent aroxy, thioaroxy, diester phosphate, diester pyrophosphate, oxyalkylamino, sulfonyl or carboxyl containing up to 30 carbon atoms; and a+b+c=3. The compound is useful as a coupling and polymer processing agent and compositions containing the compound and methods of preparing polymeric material including the compound are also described.

GB-A-1509283 describes novel organo-titanates represented by the formula:
Ti(OR)₄₋ₙ(OCOR′)ₙ where OR is a hydrolyzable group; R′ is a non-hydrolyzable group; and n is between about 3.0 and 3.50, preferably from 3.1 to 3.25. R, may be a straight chain, branched or cyclic alkyl group having from 1 to 5 carbon atoms per molecule. The non-hydrolyzable groups (OCOR) are preferably formed from organic acids having 6 to 24 carbon atoms, such as stearic, isostearic, oleic, linoleic, palmitic, lauric and tall oil acids. The compounds are used for treating inorganic solids to improve the dispersion of the inorganic solids in polymeric compounds and to improve the physical properties of the filled polymeric compounds, i.e. the organo-titanates are used as coupling agents.

Monte and Sugerman (Journal of Cellular Plastics, November-December 1985, p385) describe the use of various neoalkoxytitanates and neoalkoxyzirconates as coupling agents in different polymer systems. They conclude that certain of the compounds are capable of directly catalysing the polyol-isocynate reaction in addition to bonding polymer to substrate.

U.S. Pat. No. 2,846,408 describes a process for preparing cellular polyurethane plastics of specified pore structure using metallic compounds defined by the general formula Me(OR)ₘXₙ₋ₘwhere R is alkyl and X is an organic carboxylic acid radical including lauric, stearic, palmitic, naphthenic and phenylacetic acids, m is at least 1 and n is the valence of the metal Me. Me includes titanium, zirconium and tin.

U.S. Pat. No. 2,926,148 describes catalysts for the reaction between a diisocyanate and a mixture of alcohols to form resins. The catalysts include, apart from tin compounds, tetralkyl titanates and zirconates and various titanium esters which include triethanolamine titanate-N-stearate, triethanolamine titanate-N-oleate, octylene glycol titanate and triethanolamine titanate.

U.S. Pat. No. 6,133,404 describes the use of monoalkoxytitanates as additives useful in the preparation of biodegradeable polyester compositions.

U.S. Pat. No. 5,591,800 describes the manufacture of polyesters using a cyclic titanium catalyst such as a titanate compound formed by the reaction of a tetra-alkyl titanate and a triol. U.S. Pat. No. 5,902,835 describes titanium, zirconium or hafnium blowing catalyst compositions for the production of polyurethane foams in which the blowing catalyst is a compound represented by the following formulae: [M(L1)(L2)(L3)(L4)]n, [M(L1)(L2)(L3)]n, IM(L1)(L2)]n, [M(L1)]n wherein M is titanium, zirconium, or hafnium; n ranges from 1to 20; and each of L1, L2, L3, and L4 is the same or different ligand selected from the following groups: (1) oxygen, sulfur and nitrogen; (2) an alcoholate, phenolate, glycolate, thiolate, carboxylate, dithiocarbamate, aminate, aminoalcoholate, phosphate, phosphonate, pyrophosphate, sulfonate, or silylamide any of which contains from 1 to 20 carbon atoms and, optionally, contains one or more functional groups, or oxygen, sulfur, nitrogen, or phosphorus-containing; (3) a chelating ligand, such as, various non-fluorine containing and non-sterically hindered beta-diketones, triethanolamine, salicylaldehyde, and salicylamide.

In GB-A-2314081, an esterification catalyst comprising the reaction product of an alkoxide or condensed alkoxide of titanium or zirconium, an alcohol containing at least two hydroxyl groups, a 2-hydroxy carboxylic acid and a base. In that patent, the preferred amount of base for monobasic 2-hydroxy acids such as lactic acid, is in the range 0.8 to 1.2 mole per mole of 2-hydroxy acid. In the case of citric acid (a tribasic acid), the preferred amount is in the range 1 to 3 moles base per mole of 2-hydroxy acid. We have found that when a catalyst composition of the type described in GB-A-2314081 is made using 1,4-butane diol as the dihydric alcohol and an inorganic base is present in the preferred concentration range, the 1,4-butane diol forms a complex with the base leading to formation of a gelled product which is not suitable for use as a catalyst.

According to the invention we therefore provide a catalyst composition comprising the reaction product of an alkoxide or condensed alkoxide of titanium, zirconium, hafnium, aluminium, iron (III), or a lanthanide, a 2-hydroxy carboxylic acid, a base and optionally an alcohol containing at least two hydroxyl groups.

According to a further aspect of the invention, we also provide a composition comprising:
a) either
   i) a compound having more than one hydroxy group which is capable of reacting with an isocyanate group -containing material to form a polyurethane or
   ii) a compound having more than one isocyanate group which is capable of reacting with a hydroxyl group-containing material to form a polyurethane,
b) a catalyst composition comprising the reaction product of an alkoxide or condensed alkoxide of titanium, zirconium, hafnium, aluminium, iron (III), or a lanthanide, a 2-hydroxy carboxylic acid, a base and optionally an alcohol containing at least two hydroxyl groups; and optionally
c) one or more further components selected from chain modifiers, diluents, flame retardants, blowing agents, release agents, water, coupling agents, lignocellulosic preserving agents, fungicides, waxes, sizing agents, fillers, colourants, impact modifiers, surfactants, thixotropic agents, flame retardants, plasticisers, and other binders.

According to a further aspect of the invention, we also provide a process for the manufacture of a polyurethane article, comprising the steps of:
a) forming a mixture by mixing together either
   i) a compound having more than one hydroxy group which is capable of reacting with an isocyanate group -containing material to form a polyurethane or
   ii) a compound having more than one isocyanate group which is capable of reacting with a hydroxyl group-containing material to form a polyurethane,
      with a catalyst composition comprising the reaction product of an alkoxide or condensed alkoxide of titanium, zirconium, hafnium, aluminium, iron (III), or a lanthanide; a 2-hydroxy carboxylic acid, a base and optionally an alcohol containing at least two hydroxyl groups;
b) adding to said mixture the other of the compound in a) i) or a) ii) which is not already present in the mixture,
c) forming said mixture into the required shape for the polyurethane article,
d) allowing said mixture to cure
e) optionally subjecting the mixture to specified conditions for post-cure conditioning.

The compound having more than one hydroxy group which is capable of reacting with an isocyanate group-containing material to form a polyurethane or the compound having more than one isocyanate group which is capable of reacting with a hydroxyl group-containing material to form a polyurethane may comprise a mixture of such compounds or a mixture of such compounds with different compounds, e.g. fillers or other additives etc. In particular, where the polyurethane article is intended to form a foam, the mixture of polyol or isocyanate may or of the two together may contain a blowing agent or a blowing catalyst to catalyse the reaction between isocyanate and water which generates carbon dioxide to form the foam. Suitable blowing catalysts include amines, in particular tertiary amines.

The catalyst of the invention is the reaction product of an alkoxide or condensed alkoxide of titanium, zirconium, hafnium, aluminium, iron (III), or a lanthanide, an alcohol containing at least two hydroxyl groups, a 2-hydroxy carboxylic acid and a base. Preferably, the alkoxide has the formula M(OR)ₓ in which M is titanium, zirconium, hafnium, aluminium, iron (III) or a lanthanide, R is an alkyl group and x is the valency of the metal M. More preferably R contains 1 to 6 carbon atoms and particularly suitable alkoxides include tetraisopropoxy titanium, tetra-n-butoxy titanium, tetra-n-propoxy zirconium and tetra-n-butoxy zirconium, aluminium tri-sec-butoxide.

The condensed alkoxides suitable for preparing the catalysts useful in this invention are typically prepared by careful hydrolysis of titanium or zirconium alkoxides and are frequently represented by the formula R¹O[M(OR¹)₂O]ₙR¹ in which R¹ represents an alkyl group and M represents titanium or zirconium. Preferably, n is less than 20 and more preferably is less than 10. Preferably R¹ contains 1 to 6 carbon atoms and useful condensed alkoxides include the compounds known as polybutyl titanate, polyisopropyl titanate and polybutyl zirconate.

Preferred 2-hydroxy carboxylic acids include lactic acid, citric acid, malic acid and tartaric acid. Aromatic acids such as mandelic acid may also be used. Some suitable acids are supplied as salts, hydrates or as aqueous mixtures. Acids in this form as well as anhydrous acids are suitable for preparing the catalysts used in this invention. Preferably the catalyst contains 1 to 4 moles (more preferablyl 1.5 to 3.5 moles) of 2-hydroxy acid per mole of titanium, zirconium, hafnium, aluminium, iron (III), or lanthanide.

The base used in preparing the catalyst composition is generally an inorganic base and suitable bases include aqueous solutions of salts of weak acids with metals selected from Group IA or IIA of the periodic table of elements or with zinc, aluminium, iron(II), copper(II), nickel, cobalt (II), manganese (II), lanthanum, cerium, neodymium, and samarium. Preferred bases include sodium hydroxide, potassium hydroxide, ammonium hydroxide, lithium hydroxide, sodium carbonate, magnesium hydroxide, calcium hydroxide, aluminium acetate, zinc oxide, caesium carbonate, zirconium hydroxycarbonate and ammonia. The molar ratio of base to 2-hydroxy carboxylic acid is preferably in the range 0.05 to 1.5:1 and more preferably in the range 0.1 to 1.2:1, although if a more basic composition is required then more base may be used. Where the 2-hydroxy acid contains more than one carboxylic acid group, such as in citric acid for example, the preferred molar ratios given are per mole equivalent of carboxylic acid functionality. In general, the amount of base present is usually in the range 0.05 to 12 moles (preferably from 0.5 to 4) per mole of titanium, zirconium, hafnium, aluminium, iron (III), or lanthanide.

Preferably the alcohol containing at least two hydroxyl groups is a dihydric alcohol e.g. 1,2-ethanediol, 1,2-propanediol, 1,3-propanediol, 1,4-butane diol or a dihydric alcohol containing a longer chain such as diethylene glycol or a polyethylene glycol. The catalyst can also be prepared from a polyhydric alcohol such as glycerol, trimethylolpropane or pentaerythritol. The presence of the alcohol is optional but in preferred compositions, the alcohol is present. When present, the alcohol provides a liquid composition which is easily handled as a polyurethane catalyst. When the alcohol is not present, a liquid composition may be obtained through the addition of water. Preferably the catalyst is prepared by reacting a dihydric alcohol with an alkoxide or condensed alkoxide in a ratio of from 2 to 12 moles (more preferably 4 to 8 moles) of dihydric alcohol to each mole of the titanium, zirconium, hafnium, aluminium, iron (III), or lanthanide.

It is frequently convenient to add water together with the base when preparing the catalysts.

The catalyst can be prepared by mixing the components (alkoxide or condensed alkoxide, dihydric alcohol or water (if used), 2-hydroxy acid and base) with removal of any by-product, (e.g. isopropyl alcohol when the alkoxide is tetraisopropoxytitanium), at any appropriate stage. In one preferred method the alkoxide or condensed alkoxide and dihydric alcohol are mixed and subsequently, 2-hydroxy acid and then base (or a pre-neutralised 2-hydroxy acid solution), is added. In an alternative preferred method the alkoxide or condensed alkoxide is reacted with the 2-hydroxy acid and by-product alcohol is removed. Base is then added to this reaction product followed by a dihydric alcohol or water to produce the reaction product which is a catalyst in the process of the invention. If desired, further by-product alcohol can then be removed by distillation. An aqueous solution of the 2-hydroxy acid or a salt thereof may be used. The catalyst may be diluted in a solvent, which may be an alcohol or water, for example a compound which is to be used in the polyurethane reaction. As an example the solvent may be a diol such as 1,4-butanediol which is often used as a chain extender in commercial polyol compositions supplied for polyurethane manufacture.

The compound of the invention is particularly useful as a cure catalyst for the reaction between a hydroxy-functionalised molecule, such as a polyol, and an isocyanate-functionalised molecule, such as a polyisocyanate. This reaction forms the basis of many commercially available two-component polyurethane systems. The polyol component may be any suitable for the manufacture of polyurethanes and includes polyester-polyols, polyester-amide polyols, polyether-polyols, polythioetherpolyols, polycarbonate polyols, polyacetal polyols, polyolefin polyols polysiloxane polyols, dispersions or solutions of addition or condensation polymers in polyols of the types described above, often referred to as “polymer” polyols. A very wide variety of polyols has been described in the prior art and is well known to the formulator of polyurethane materials.

Typically, a mixture of polyols is used to manufacture polyurethane having particular physical properties. The polyol or polyols is selected to have a molecular weight, backbone type and hydroxy functionality which is tailored to the requirements of the formulator. Typically the polyol includes a chain extender, which is often a relatively short-chain diol such as 1,4-butane diol or diethylene glycol or a low molecular weight polyethylene glycol. Alternative chain extenders in commercial use, such as diamines, e.g. MOCA (4,4-methylene bis (2-chloroaniline)) may also be used.

The isocyanate compositions used for polyurethane manufacture suitable for use with the catalysts of the present invention may be any organic polyisocyanate compound or mixture of organic polyisocyanate compounds which are commercially useful for the purpose. Suitable organic polyisocyanates include diisocyanates, particularly aromatic diisocyanates, and isocyanates of higher functionality. Examples of suitable organic polyisocyanates include aliphatic isocyanates such as hexamethylene diisocyanate and isophorone diisocyanate; and aromatic isocyanates such as m- and p-phenylene diisocyanate, tolylene-2,4- and tolylene-2,6-diisocyanate, diphenylmethane-4,4′-diisocyanate, chlorophenylene-2,4-diisocyanate, naphthylene-1,5-diisocyanate, diphenylene-4,4′-diisocyanate, 4,4′-diisocyanate-3,3′-dimethyl-diphenyl, 3-methyldiphenylmethane-4,4′-di-isocyanate and diphenyl ether diisocyanate; and cycloaliphatic diisocyanates such as cyclohexane-2,4- and -2,3-diisocyanate, 1-methylcyclohexyl-2,4- and -2,6-diisocyanate and mixtures thereof and bis-(isocyanatocyclohexyl)methane and triisocyanates such as 2,4,6-triisocyanatotoluene and 2,4,4-tri-isocyanatodiphenylether.

Modified polyisocyanates containing isocyanurate, carbodiimide or uretonimine groups may be used. The polyisocyanate may also be an isocyanate-ended prepolymer made by reacting an excess of a diisocyanate or higher functionality polyisocyanate with a polyol for example a polyether polyol or a polyester polyol. The use of prepolymers is common in commercially available polyurethane systems. In these cases, polyols may already be incorporated in the isocyanate or prepolymer whilst further components such as chain extenders, polyols etc may be mixed with the isocyanate prepolymer mixture before polymerisation.

Mixtures of isocyanates may be used in conjunction with the organometallic composition of the invention, for example a mixture of tolylene diisocyanate isomers such as the commercially available mixtures of 2,4- and 2,6-isomers. A mixture of di- and higher polyisocyanates, such as trimers (isocyanurates) or pre-polymers, may also be used. Polyisocyanate mixtures may optionally contain monofunctional isocyanates such as p-ethyl phenylisocyanate.

Preferably the polyisocyanate is liquid at room temperature.

The organometallic composition of the invention is typically added to the polyol prior to mixing together the polyol component with the isocyanate component to form the polyurethane. However, the organometallic composition may instead be added to the isocyanate component if required.

A composition containing a catalyst composition of the present invention and a polyisocyanate and compounds reactive therewith may further comprise conventional additives such as chain modifiers, diluents, flame retardants, blowing agents, release agents, water, coupling agents, lignocellulosic preserving agents, fungicides, waxes, sizing agents, fillers, colourants, impact modifiers, surfactants, thixotropic agents, flame retardants, plasticisers, and other binders. The selection of these and other ingredients for inclusion in a formulation for a polyurethane composition is well known to the skilled person and may be selected for the particular purpose.

When the mixture has been allowed to cure it may be further conditioned to allow for post-cure. Typically this occurs when the polyurethane article, coating etc has hardened to a state in which it may be handled, de-moulded etc and then it may be held at elevated temperature, e.g. by placing in an oven, to develop or enhance the full cured properties of the article.

The catalysts of the present invention are useful for the manufacture of polyurethane foams, flexible or rigid articles, coatings, adhesives, elastomers, sealants, thermoplastic polyurethanes, and binders e.g. for oriented strand board manufacture. The catalysts of the present invention may also be useful in preparing polyurethane prepolymers, i.e. urethane polymers of relatively low molecular weight which are supplied to end-users for curing into polyurethane articles or compositions of higher molecular weight.

The catalysts are typically present in the isocyanate and/or alcohol mixture to give a concentration in the range 1×10⁴ to 10% by weight, preferably up to about 4% by weight based upon the weight of the total reaction system, i.e. the total weight of the polyisocyanate and polyol components .

The invention is illustrated by the following examples.

### EXAMPLE 1

Water (52.25 g, 2.90 moles) and citric acid monohydrate (75 g, 0.36 moles) were placed into a pre-weighed rotary evaporator flask, and heated for 15 minutes to dissolve the citric acid. The solution was allowed to cool. A vacuum was applied to the flask and titanium (IV) n-butoxide (48.5 g, 0.14 moles) (VERTEC™ TNBT) added via vacuum inlet. An azeotrope of n-butanol/water was removed under reduced pressure. The resulting mixture was allowed to cool before the dropwise addition of 5% magnesium hydroxide in water (145 g, 0.125 moles). 1,4-butanediol (103 g, 1.14 moles) was then added dropwise, whilst stirring. An azeotrope of n-butanol/water was removed under reduced pressure. The resulting mixture was allowed to cool before 50% dilution with 1,4-butanediol to yield a slightly hazy solution with a titanium content of 1.54%.

### EXAMPLE 2

Example 1 was repeated except that 5% lithium hydroxide in water (105 g, 0.125 moles) was added in place of the magnesium hydroxide. The resulting mixture was allowed to cool before 50% dilution with 1,4-butanediol to yield a slightly hazy solution with a titanium content of 1.33%.

### EXAMPLE 3

Example 1 was repeated except that 5% aluminium acetate ((CH₃CO₂)₂AlOH) in water (408 g, 0.125 moles) was added in place of the magnesium hydroxide. The resulting mixture was allowed to cool before 50% dilution with 1,4-butanediol to yield a slightly hazy solution with a titanium content of 1.84%.

### EXAMPLE 3A

Example 3 was repeated using a 10% aqueous solution of aluminium acetate to make a higher pH composition.

### EXAMPLE4

Example 1 was repeated except that 5% zinc oxide in water (203, 0.125 moles) was added in place of the magnesium hydroxide. The resulting mixture was allowed to cool before 50% dilution with 1,4-butanediol to yield a slightly hazy solution with a titanium content of 2.10%.

### EXAMPLE 5

Example 1 was repeated except that 5% caesium carbonate in water (407 g, 0.125 moles) was added in place of the magnesium hydroxide. The resulting mixture was allowed to cool before 50% dilution with 1,4-butanediol to yield a slightly hazy solution with a titanium content of 1.71%.

### EXAMPLE 6

50% Citric acid solution (0.18 mole, 69.12 g) was taken in a rotary evaporator flask to which aluminium tri-sec-butoxide (0.0639 mole, 15.75 g) was added dropwise from a dropping funnel. On stirring it dissolved giving a cloudy suspension (slightly exothermic). The mixture was distilled under vacuum at 80° C. for nearly 2 hours to remove water and butanol. 50 g (0.0625 mole) of a 5% (by wt) aqueous NaOH solution was added dropwise followed by 1,4-butanediol (0.57 mole, 51.375 g). The remaining butanol and water were removed at 110° C. under vacuum.

### EXAMPLE 7

Example 6 was repeated with the exception that 101.72 g (0.0625 mole) of a 5% (by wt) aqueous ZnO solution was added instead of the NaOH solution.

### EXAMPLE 8

385 g (3.76 mole) of 88% lactic acid was placed into weighed 2-litre fishbowl flask and 640 g de-mineralised water added. 534 g (1.88 mole) of tetra-isopropoxy) titanium (VERTEC™ TIPT) was slowly added to the stirred lactic acid solution over a period of about 30 minutes, and the temperature maintained below 40° C. A hazy white suspension was produced which was then refluxed at 85-90° C. for one hour. The mixture was allowed to cool before a still head and condenser were attached to the flask and the mixture maintained at 100° C. for 2-3 minutes to remove isopropanol. The mixture was again allowed to cool to room temperature before slow addition of 288 g (3.76 mole) 28% ammonium hydroxide solution. The product contained 8.26% Ti (by weight) and had a specific gravity of 1.231 g/cm³.

### EXAMPLE9

426 g, 1.5 mole, TIPT was placed into a weighed 2 litre fishbowl flask, fitted with a stirrer, thermometer, condenser and lid. The flask was placed in a water bath and fitted with a weighed 500 ml dropping funnel containing 648 g, (6 moles), diethylene glycol (DEG). The DEG was run slowly into the TIPT over a period of around 30 minutes, so that the temperature did not exceed 40° C. The final mix was stirred for 5 minutes, to complete the reaction, and allowed to cool below 30° C. 306.8 g 88% w/w lactic acid (3 mole) was slowly added to the mix, from a weighed 500 ml dropping funnel, and the temperature again maintained below 40° C. The reaction flask was then fitted with a dip tube connected to a supply of ammonia gas and the mix was neutralized by bubbling ammonia gas through the stirred mix. The pH of the mix was taken at regular intervals using moistened 1-14 pH paper and the mix temperature maintained below 40° C. The neutralized mix was transferred to a weighed Buchi flask, which was fitted to a rotary evaporator. The mix was then stripped to constant weight, at temperatures up to 85°C., to remove 360 g IPA, (6 moles) and 37 g water (2 moles) (from the 88% lactic acid). The final stripped mix was a clear orange coloured liquid containing 6.89% Ti, and having a specific gravity of 1.260 g/cm³, a viscosity of 10.22 poise, a flash point of 115° C. The pH of 10% solution in water was between 5 and 6.

### EXAMPLE 10

415 g (4.06 Mole) of 88% lactic acid was placed into weighed 2-litre fishbowl flask and 640 g de-mineralised mineralised water added. 534 g (1.88 mole) VERTEC™ TIPT was slowly added to the stirred lactic acid solution over a period of about 30 minutes, and the temperature maintained below 400° C. A hazy white suspension was produced which was then refluxed at 85-90° C. for one hour. The mixture was allowed to cool before a still head and condenser were attached to the flask and the mixture maintained at 100° C. for 2-3 minutes to remove isopropanol. The flask was again cooled below 30° C. and 30 g of zirconium carbonate hydroxide powder was gradually added into the stirred mix. Release of CO₂ occurred, causing effervescence and some foaming. The mix was stirred for a further 5 minutes, to give maximum dispersion and solution of the zirconium carbonate. The resulting mix was a hazy yellow-white colour. 100 ml of de-mineralised water was slowly added to the stirred mix, to try to dissolve the haziness, but with little effect, even after heating to 800° C. A further 100 mls of water was again added, but the mix again remained hazy. Finally, 246 g (4.05 mole) 28% Ammonium hydroxide solution was slowly added. The mix became clear after addition of around 90% of the ammonia solution. The remaining ammonia was added and the mix stirred for 5 minutes to give complete dispersion. The product contained 7.47% of Ti, 2.1- 2.23% of Zr, had a specific gravity of 1.226 g/cm3 and a pH (10% in water) of 8-9.

### EXAMPLE 11

a) 220.6 g of citric acid monohydrate crystals was placed into weighed 1-litre fishbowl flask and 526.4 g de-mineralised water added. The temperature of the mix was raised to around 25° C. to dissolve the citric acid. 106.5 g (0.375 mole) VERTEC™ TIPT was added slowly into the stirred mix and the temperature maintained below 40° C. The resulting white suspension was refluxed at 85-90 ° C. for one hour to give a clear solution. The mix was cooled, before a still head and condenser were attached to the flask, to enable distillation of iso-propanol and water. A thermometer was fitted into a still head and the mix heated to 100° C., and maintained at this temperature for 2-3 minutes to remove all IPA.
b) The flask was again allowed to cool to room temperature before addition of ammonia solution which was prepared by diluting 28% ammonia solution 1:1 by weight. 61.5 g of this 1:1 w/w solution (0.5 mole NH₃) was slowly run into the titanium citrate mix. The pH of the mix was raised from 1 to 2 during the ammonia addition.
c) 78.6 g zinc citrate dihydrate (0.129 mole ) was dissolved in a further 123.3 g of the prepared ammonia solution. This solution was slowly added to the stirred titanium-containing mixture (pH raised to about 3). A further 61.5 g of the ammonia solution was added to further increase the pH of the mix to 4.

### EXAMPLE 12

The method of part a of Example 11 was repeated to make a titanium citrate solution, using 210.3 g (1.0 mole) of citric acid monohydrate crystals, 520 g of de-mineralised water, 142.0 g (0.5 mole) of VERTEC™ TIPT. About 120 g of diluted (1: 1 wlw) ammonia'solution (1 mole NH₃) was slowly added and the pH of the mix after this addition was around 4. A further 60.7 g (1 mole) of 28% ammonium hydroxide solution was again diluted 1:1 w/w with water and added to the mix to further increase the pH. The mixture was made up with water to give a total weight of 1000 g and filtered to give a clear solution containing 2.37% Ti and having a pH (10% solution) of 5 and a specific gravity of 1.138 g/cm³.

### EXAMPLE 13

The method of part a of Example 4 was repeated to make a titanium citrate solution, using 480 g (1.25 mole) of a pre-mixed 50% citric acid solution, 300 g of de-mineralised water, 142.0 g (0.5 mole) of VERTEC™ TIPT.

After removal of IPA by distillation, the remaining mixture was cooled and neutralized with 76 g 28% ammonium hydroxide solution (1.25 mole NH₃) and then, 376 g (6.06 moles) of ethylene glycol was added from a dropping funnel. The mixture was stirred for 5 minutes to give a homogeneous though slightly hazy mix having a pH of 4. 250 ml was removed for analysis and a further 88.3 g ammonium hydroxide solution was added from a dropping funnel into the remaining mix (936 g), increasing the pH to 6. The Ti content was 1.87% and the SG 1.064 g/cm³.

### EXAMPLE 14

The catalysts of the invention were used as catalysts in the preparation of polyurethane foams. All the catalysts were found to be hydrolytically stable. 50 g of a commercial polyether polyol preparation containing an organic filler, surfactants, fillers, pigments, a tertiary amine (as blowing agent), 1,4-butane diol (chain extender) and water (for the foam blowing reaction) was placed in a disposable speed mixer cup. A measured amount of the appropriate catalyst (see Table 1) was added and the mixture was mixed at 300 rpm. 35 g of 4,4-methylenebis phenylisocyanate (MDI) based prepolymer (% NCO=18.4) was added and the whole mixture was hand mixed for 20 seconds, then poured into a disposable beaker. A thin wire of (HI-92704C) K-thermocouple was inserted to record the exotherm of the foaming reaction. The foam height and cream time were recorded for each mixture. The same preparation was carried out using a commercial tin catalyst as a comparison. The density (g/l) of the foams was measured by weighing to determine the mass and using a water displacement method to determine the volume of the foam.

The results show that foams of at least comparable density to those produced using the tin catalyst were produced using the catalysts of the invention. The longer cream times are of benefit in some applications where time to mould the mixtures is required before the foam is formed. Some catalysts were mixed with the polyol and stored before use in order to determine the effect of storage in contact with polyol and water. The results show that the catalysts have a good shelf life.

In order to show the effect of the amine catalyst used, the preparations were repeated in the absence of the amine catalyst. The product polyurethane became gelled but the foams did not rise and the exotherms were low (<40 ° C.) indicating that the amine catalyst used functioned as the blowing catalyst, whilst the catalysts of the invention were functioning as gelation catalysts.

TABLE 1

| | | Amount of | Cream | | |
|---|---|---|---|---|---|
| | Foam | catalyst | time | Den- | Exo- |
| Catalyst | height(mm) | (g) | (mins) | sity(g/l) | therm(° C.) |
| Example 1 | 50 | 0.2 | 18-21 | 463 | 91 |
| Example 2 | 56 | 0.2 | 18-21 | 416 | 98 |
| Example 3 | 79 | 0.2 | 18-21 | 311 | 98 |
| Example 4 | 60 | 0.2 | 18-21 | 388 | 95 |
| Example 5 | 49 | 0.2 | 18-21 | 471 | 94 |
| Example 6 | 60 | 0.2 | 20-25 | 353 | 98 |
| Example 6 | 46 | 0.07 | 20-25 | 447 | 100 |
| Example 7 | 47 | 0.07 | 20-25 | 475 | 100 |
| Example 7 | 45 | 0.06 | 20-25 | 463 | 98 |
| Example 8 | 52 | 0.055 | 20-22 | 299 | 98 |
| Example 9 | 47 | 0.058 | 20-22 | 324 | 95 |
| Example 10 | 41 | 0.055 | 20-22 | 383 | 93 |
| Example 11 | 43 | 0.051 | 20-22 | 374 | 99 |
| Example 12 | 45 | 0.054 | 20-22 | 342 | 91 |
| Example 13 | 73 | 0.05 | 20-22 | 303 | 95 |
| Tin | 53 | 0.2 | 18-21 | 399 | 95 |
| (comparison) | | | | | |
| Example 8* | 79 | 0.055 | 20-22 | 234 | 97 |
| Example 9* | 55 | 0.054 | 20-22 | 380 | 97 |
| Example 12* | 67 | 0.05 | 20-22 | 322 | 100 |

*Catalyst mixed with polyol and stored for 8 days before addition of isocyanate.

1. A process for the manufacture of a polyurethane article, comprising the steps of:
a) forming a mixture by mixing together either
a compound having more than one hydroxy group which is capable of reacting with an isocyanate group-containing material to form a polyurethane or
a compound having more than one isocyanate group which is capable of reacting with a hydroxyl group-containing material to form a polyurethane,
with a catalyst composition comprising the reaction product of:
i. an alkoxide or condensed alkoxide of titanium, zirconium, hafnium, aluminium, iron (III), or a lanthanide,
ii. a 2-hydroxy carboxylic acid, and
iii. a base
b) adding to said mixture the other of the compound having more than one hydroxyl group which is capable of reacting with an isocyanate group-containing material to form a polyurethane or the compound having more than one isocyanate group which is capable of reacting with a hydroxyl group-containing material to form a polyurethane,
c) forming said mixture into the required shape for the polyurethane article, and
d) allowing said mixture to cure

2. A process as claimed in claim 1, wherein the polyurethane article is a foam and a blowing catalyst is added to the mixture formed in step a).

3. A process as claimed in claim 10, wherein in said catalyst composition, the alcohol is selected from the group consisting of 1,2-ethanediol, 1,2propanediol, 1,3-propanediol, 1,4-butane diol, diethylene glycol and a polyethylene glycol.

4. A process as claimed in claim 1, wherein, in said catalyst composition, the 2-hydroxy carboxylic acid is selected from the group consisting of lactic acid, citric acid, malic acids and tartaric acid.

5. A process as claimed in claim 1, wherein, in said catalyst composition, the molar ratio of acid to titanium or zirconium in the reaction product is from 1 to 4 moles acid per mole of titanium, zirconium, hafnium, aluminium, iron (III), or lanthanide.

6. A process as claimed in claim 1, wherein, in said catalyst composition, the base is selected from the group consisting of sodium hydroxide, potassium hydroxide, ammonium hydroxide, lithium hydroxide, sodium carbonate, magnesium hydroxide, calcium hydroxide, aluminium acetate, zinc oxide, caesium carbonate, zirconium hydroxycarbonate and ammonia.

7. A composition comprising:
a) either
i) a compound having more than one hydroxy group which is capable of reacting with an isocyanatc group-containing material to form a polyurethane or
ii) a compound having more than one isocyanate group which is capable of reacting with a hydroxyl group-containing material to form a polyurethane,
and
b) a catalyst composition comprising the reaction product of:
i. an alkoxide or condensed alkoxide of titanium, zirconium, hafnium, aluminium, iron (III), or a lanthanide,
ii. a 2-hydroxy carboxylic acid, and
iii. a base

8. catalyst composition comprising the reaction product of:
i. an alkoxide or condensed alkoxide of titanium, zirconium, hafnium, aluminium, iron (III), or a lanthanide,.
ii. a 2-hydroxy carboxylic acid, and iii. a base and

9. A catalyst composition as claimed in claim 8, wherein component i) is an alkoxide or condensed alkoxide of aluminium, iron (III), or a lanthanide.

10. A process as claimed in claim 1, wherein the catalyst composition further comprises an alcohol containing at least two hydroxyl groups.

11. A process as claimed in claim 1, further comprising the step of subjecting the mixture to specified conditions for post-cure conditioning.

12. A composition as claimed in claim 7, wherein the catalyst composition further comprises an alcohol containing at least two hydroxyl groups.

13. A composition as claimed in claim 7, further comprising one or more further components selected from chain modifiers, diluents, flame retardants, blowing agents, release agents, water, coupling agents, lignocellulosic preserving agents, fungicides, waxes, sizing agents, fillers, colourants, impact modifiers, surfactants, thixotropic agents, flame retardants, plasticisers, and other binders.

14. A catalyst composition as claimed in claim 8 further comprising an alcohol containing at least two hydroxyl groups.
